(19) United States
(12) Patent Application Publication
(10) Pub. No.: US 2022/0087220 A1
(43) Pub. Date: Mar. 24, 2022

(54) SYSTEM AND METHOD FOR TRAINING CANINES TO DETECT COVID-19 BY SCENT FOR IMPLEMENTATION IN MOBILE SWEEPS

(71) Applicant: K2 Solutions, Inc., Southern Pines, NC (US)

(72) Inventors: Lane Kjellsen, Carthage, NC (US); Lanie Teresa DeLong, Berthoud, CO (US); Rachel Marie Royston, Pinehurst, NC (US)

(73) Assignee: K2 Solutions, Inc., Southern Pines, NC (US)

(21) Appl. No.: 17/314,816

(22) Filed: May 7, 2021

Related U.S. Application Data
(60) Provisional application No. 63/081,058, filed on Sep. 21, 2020.

(51) Int. Cl. A01K 15/02; A01K 11/00; A01K 29/00

(52) U.S. Cl. CPC A01K 15/021; A01K 29/005; A01K 11/008

(57) ABSTRACT

Systems and methods for training canines to detect a virus by scent, and field implementation of a trained canine sweeping for the virus in a public setting with high mobility, the public setting selected by predictive analytics software. The trained canine is brought to a location desired to be swept and moves freely around the location. The canine searches for target odors or scents associated with the virus and is able to follow the target odor or scent back to its source. A person identified by a trained canine as a source of the target odor or scent associated with the virus is quarantined or subjected to further testing to confirm if they have the virus.

### CROSS REFERENCES TO RELATED APPLICATIONS

This application claims priority to and the benefit of U.S. Provisional Application No. 63/081,058, filed Sep. 21, 2020, which is incorporated by reference in its entirety.

### BACKGROUND OF THE INVENTION

### 1. Field of the Invention

The present invention relates to a system and method for training canines to detect viruses by a target scent and more specifically to a system and method for field implementation of a trained canine sweeping for viruses in a public setting with high mobility.

### 2. Description of the Prior Art

It is generally known in the prior art to provide canines for detecting explosives and narcotics in a laboratory or other controlled setting.

Prior art patent documents include the following:

US Patent Publication No. 2016/0345539 for System and method for detecting a medical condition in a subject by Michal Mark-Danieli and Asher Castiel, filed Jan. 25, 2015 and published Dec. 1, 2016 is directed to a method for training an animal to detect a condition, such as cancer, in a human or animal individual. A training sample is presented to the animal to be trained where, the training sample is a gaseous sample or vapor generated by a cell population associated with the predetermined condition. The population of cells associated with the predetermined condition may be, for example, a culture of an established cell line associated with the predetermined condition. Simultaneously with, or subsequent to, presentation of the training sample, the animal is subjected to an adverse stimulus, such as an electric shock. The animal is allowed animal to perform a first predetermined response in order to avoid, escape or terminate the adverse stimulus. The invention also provides a method for detecting a condition, such as cancer, in an individual in which a trained animal performs the predetermined response upon exposure to vapors from body fluid of an individual affected with the condition.

US Patent Publication No. 2017/0290294 for Controllable scent sample dispenser, and animal training and testing system for detecting scents by Rene Linssen et al., filed Jun. 22, 2017 and published Oct. 12, 2017 is directed to a controllable scent sample dispenser has a microdosing device for outputting, during an activation state, a scent sample at a scent sample outlet to the environment, wherein the microdosing device is placeable adjacent to an animal's nose so that a distance between the outlet of the microdosing device and a nare or nostril of the animal's nose is within a predefined range, and a microdosing driver unit for adjusting a dosing rate of the scent sample output at the scent sample outlet by selectively activating the microdosing device.

US Patent Publication No. 2020/0154672 for Method for training a dog and a training-set by Susanna Paavilainen, filed Sep. 23, 2016 and published May 21, 2020 is directed to a system comprising a set of cans comprising at least two cans of which one can contains a specific scent, each can including a tab providing a dog a means to express choosing of the can, and transmitter for transmitting the information of whether the dog has expressed the can with the specific scent or a can with no said specific scent and an apparatus comprising at least one processing core, at least one memory including computer program code, the at least one memory and the computer program code being configured to, with the at least one processing core, cause the apparatus at least to store the transferred information of multiple expressions, process the stored information in order to calculate at least how many of the multiple expression are correct, and display the results of the processed data.

U.S. Pat. No. 10,455,817 for Animal olfactory detection of a disease as control for health metrics collected by medical toilet by David R. Hall et al., filed Oct. 4, 2016 and issued Oct. 29, 2019 is directed to a medical toilet that comprises one or more medical devices and a control for the metrics they collect. The medical devices may be used to collect metrics relevant to a user's health status. The medical toilet further comprises a conduit through which volatile organic compounds travel from the toilet bowl to the environment outside the toilet. An animal trained to identify the scent of bodily waste collected from a user that is afflicted with a disease perceives the scent of the user's bodily waste traveling through the conduit and performs a defined act upon perceiving the disease scent. The metric collected by the medical device(s) may be used to diagnose the same disease as that which the animal is trained to identify. The diagnosis provided by the animal by way of the conduit acts as a control for the metric collected by the medical device.

U.S. Pat. No. 9,545,081 for Scent training device by Patrick L. Nolan, filed Oct. 28, 2014 and issued Jan. 17, 2017 is directed to a device for training animals such as rats, dogs, etc. to recognize and associate target odors/scents with food. The training device, sometimes referred to herein as an odor or scent training device, includes a feeding dish/pan that is configured to have food positioned therein. The scent training device creates a scent curtain of a target scent above the food so that the animal's nose and head first penetrate the scent curtain before the animal can eat the food. As such, each time the animal reaches for more food in the feeding dish, an association between the reward of food and the target scent is strengthened.

US Patent Publication No. 2020/0008395 for Method of using human excrement and secretions for early detection of parkinson's disease by Laurie Kathern Mischley, filed Jul. 15, 2019 and published Jan. 9, 2020 is directed to methods for early detection of Parkinson's diseases (PD), especially in individuals showing no motor symptoms, by detecting PD-distinct scent using a trained animal (such as a canine). Specific rigorous animal training in scent identification through both patient contact and training samples are also disclosed.

U.S. Pat. No. 7,633,397 for Detection system employing trained animals by Regina Elvira Dugan, filed Jan. 5, 2007 and issued Dec. 15, 2009 is directed to a detection system includes a mobile unit in the form of a trained/in-training animal controlled, either directly or indirectly, by a handler. The mobile unit carries a portable electronics package linked to a remote unit. The animal is trained to search for target odors originating from a specified object, such as drugs, weapons, chemicals, a person or the like. Once a target odor is detected, data generated by the animal, as determined through body position, biometric or other sensors provided in the portable electronics, is either stored in memory for later review or forwarded to a remote unit for immediate evaluation. In this manner, the handler is provided with confirmation that the animal has sensed a target odor, thereby increasing the overall efficacy of the detection system and reducing the possibility of incorrectly reinforcing responses that are not associated with the desired target odors.

US Patent Publication No. 2019/0227053 for Bio-electric nose by Dmitry Rinberg et al., filed Jun. 23, 2017 and published Jul. 25, 2019 is directed to an animal-based chemical detectors that can be customized to detect a wide variety of chemicals under real-world conditions. Methods and systems for brain/machine interface devices using electrodes to read odor-signatures from the patterns of activated glomeruli, for example in the rodent olfactory bulb.

U.S. Pat. No. 10,278,365 for Apparatus and method for dog training by Golan Nir and Tamir Goren, filed Oct. 23, 2013 and issued May 7, 2019 is directed to an apparatus for training a subject dog to perform target odor detecting operations within a completely confined compartment, which comprises a partial compartment having at least three angularly different surfaces to define an interior. The surfaces are sufficiently long to provide a subject dog located within the interior with a sensation of being at least partially confined. An air inlet is defined by a configuration of the partial compartment, by which odor laden air is introducible into the interior and is detectable by the nose of the subject dog. A dog interfaceable member is operatively connected to the partial compartment and activatable upon detection of a predetermined target odor.

U.S. Pat. No. 6,425,350 for Training method and apparatus for training and using dogs in the detection of contaminants by Susan Bulanda, filed Dec. 16, 2000 and issued Jul. 30, 2002 is directed to a device simulating one or more of the noxious contaminants is used to train dogs to detect these contaminants in varying situations. A non-intrusive method for training one or more dogs to detect contaminants in a building or other structure, using the device, is also provided. By using dogs trained by the method, trainers can then instruct these contaminant-detecting dogs to precisely and efficiently locate areas of active contamination for future remediation without damage to the site under investigation.

U.S. Pat. No. 9,807,979 for Explosive and narcotics detection dog training with vapour or aerosol air impregnation by Timothy Graham Foat et al., filed Aug. 30, 2012 and issued Nov. 7, 2017 is directed to devices and methods for the impregnation of air with the vapor or aerosol of a substance in a ‘controllable manner to enable the testing or training of detection means to evaluate and quantify the presence of the substance in an enclosed volume, and in particular to enable production of training aids and quality assurance test items for use in canine-olfaction based security screening.

U.S. Pat. No. 8,931,327 for Dynamic canine tracking method for hazardous and illicit substances by John Pearce et al., filed Aug. 27, 2010 and issued Jan. 13, 2015, is directed to a method of training a canine for detection, the method comprises choosing a detector canine that demonstrates a high level of independent search behavior, teaching the canine that the source of a target odor is not limited to stationary objects, teaching the canine to follow a vapor-wake of a moving target, teaching the canine to sample air currents and teaching the canine to follow the vapor-wake to the target and give a final response.

### SUMMARY OF THE INVENTION

The present invention relates to a system and method for training canines to detect a virus by a target scent and more specifically to an operational system and method for field implementation of a trained canine sweeping for a virus in a public setting with high mobility.

It is an object of this invention to use trained canines to identify a virus by a target scent in an operational setting such that the spread of the virus is slowed or stopped. By screening high-foot-traffic areas with canines, those who have the virus can be quarantined and prevented from spreading the virus to others.

It is another object of this invention to use trained canines to screen large areas for viruses, adding security without slowing down pedestrians.

In one embodiment, the present invention relates to a method for training canines to detect viruses or diseases by a target scent.

In another embodiment, the present invention relates to a system for detecting viruses or diseases using a trained canine in an operational setting.

In yet another embodiment, the present invention relates to a predictive analytics system to determine target areas for canine sweeps.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a top-down view of a trained canine sweeping an area for a virus.

FIG. 2 illustrates a device including an application.

FIG. 3 is a schematic diagram of a system of the present invention.

### DETAILED DESCRIPTION

The present invention is generally directed to a system and method for training canines to detect viruses by a target scent and more specifically to an operational system and method for field implementation of a trained canine sweeping for viruses in a public setting with high mobility. The canine detects the target scent emitted or emanating from a person and follows the scent to its source, indicating to a handler that the person has a virus.

In one embodiment, the present invention relates to a method for training canines to detect viruses or diseases by a target scent.

In another embodiment, the present invention relates to a system for detecting viruses or diseases using a trained canine in an operational setting.

In yet another embodiment, the present invention relates to a predictive analytics system to determine target areas for canine sweeps.

None of the prior art discloses a system for training canines to detect airborne virus particles. Additionally, none of the prior art discloses using trained canines for high mobility sweeps of target scents or odors in operational settings. Furthermore, none of the prior art discloses predictive analytics software to determine target areas for trained canines to sweep.

With the spread of COVID-19, there has arisen a need for a method to quickly and accurately screen people for viruses. Efforts to control the spread of the virus would benefit greatly from a reliable and nonintrusive way to detect people who have the virus in large crowds.

Current virus detection methods rely on the collection of samples, which is both costly and time-consuming. Furthermore, current detection methods cannot give instantaneous feedback. A person tested for a virus must either be held in quarantine until the test results come back, or else be allowed in public where he or she could potentially be spreading the virus. Furthermore, current detection methods rely on a person deciding to be tested for a virus. The proactive nature of the present invention does not rely on a person taking the initiative to be tested.

A canine such as a dog has a sense of smell orders of magnitude stronger than a human's sense of smell, and dogs are able to detect concentrations as small as in the parts per trillion range. Dogs have long been used to detect narcotics and explosives and have also been used in limited applications to detect disease biomarkers in humans to catch cancer and/or certain diseases. Canine detection is advantageous due to its speed, its reliability, and due to its noninvasive nature.

The present invention advantageously provides for training of canines to reliably and nonintrusively detect the presence of a virus in large crowds. These trained canines are able to smell either the virus itself or volatile organic compounds (VOCs) uniquely associated with a particular virus that are emitted by a human who has the virus. In this way, a canine trained according to the present invention is able to detect which humans have the virus.

Canine virus detection is advantageous over prior virus detection methods due to its real-time nature and due to the increased number of people that can be effectively screened simultaneously. Canine virus detection is also advantageous over prior virus detection methods due to its proactive nature.

Referring now to the drawings in general, the illustrations are for the purpose of describing one or more preferred embodiments of the invention and are not intended to limit the invention thereto.

Training Canines to Detect Viruses

A canine is given both live odor training and operational training. Live odor training involves the exposure of the canine to a target scent, while operational training involves the canine sweeping an environment that mimics the environment of the canine's eventual operational deployment. In one embodiment, live odor training and operational training are conducted separately.

Live odor training includes exposing the canine to the target scent, where the target scent is the scent of a live virus. The canine is exposed to the target scent by a box, can, scent wheel, or another container with a sample of the virus inside. The canine is imprinted on live volatile organic compounds (VOCs) specific to the virus. In an alternate embodiment, the target odor is a pseudo odor.

Operational training includes training the canine in an environment that mimics their eventual operational deployment. In one embodiment, the training environment comprises heavy foot traffic. In one embodiment, heavy foot traffic is foot traffic with a density of over 0.35 people per square meter. To avoid transmitting a virus by coughing, sneezing, or breathing, people are encouraged to stand six feet apart. If a person is at the center of their own six-foot diameter circle of personal space, this corresponds to a 28 square foot circle (Area=π*(0.5*D)²). Converted into meters, this is one person per every 2.63 square meters. However, circles have a maximum packing density of 0.907 because circles do not tessellate, which means that each person needs approximately an additional 10% area, bringing the density to one person per 2.899 square meters, or 0.35 people per square meter. In another embodiment, heavy foot traffic is foot traffic with a density of over 0.2 people per square meter. Alternatively, heavy foot traffic is foot traffic where five or more people pass a threshold per minute.

The canine is trained in accordance with an operant conditioning training method, which is a method of learning that uses both reinforcement and punishment to modify behavior. Reinforcement is when the canine is rewarded for behavior to encourage more of that behavior. Reinforcement can be positive, where the canine is given something enjoyable as a reward, or reinforcement can be negative, where something unpleasant is taken away as a reward. In one embodiment, rewards include food, a clicker, and/or a toy. In one embodiment, the training method uses positive reinforcement. In another embodiment, the training method uses negative reinforcement. In yet another embodiment, the training method uses a combination of positive and negative reinforcement. Punishment is when the canine is reprimanded for behavior to discourage more of that behavior. Punishment can be positive, where a canine is given something unpleasant as a reprimand, or punishment can be negative, where a canine has something enjoyable taken away as a reprimand. In an alternate embodiment, the training method uses positive reinforcement, negative reinforcement, positive punishment, and/or negative punishment.

In a preferred embodiment, the training method uses positive reinforcement and negative punishment. The positive reinforcement includes a clicker or sound such as a beep and/or verbal marker, such as a positive noise, word, or statement to mark a correct response, and then further includes a reward. The reward is either given by a handler after the canine returns to the handler or the reward is given remotely by a reward device. A reward device is an electronic device that is operable to make a noise and to dispense a reward. In one embodiment, the reward device is operated remotely by the handler. The negative punishment includes withholding the positive reinforcement and the reward.

In one embodiment, the canine's training is about three months long. The canine's training is divided into at least two periods, where the at least two periods comprise an imprint period and a post-imprint period. During the imprint period, the canine's training comprises frequent, short sessions. In one embodiment, the canine is given 4-6 daily sessions of about 20 minutes each during the imprint period. The canine moves from the imprint period to the post-imprint period once the canine has met a certain milestone. During the post-imprint period, the canine's training comprises less-frequent, longer sessions. In one embodiment, the canine is given 2 daily sessions of about 30-60 minutes each during the post-imprint period.

In another embodiment, the canine is a breed of dog with a high hunt drive. Dogs with a high hunt drive are easier to train because they can more easily be motivated through a toy or play as a reward.

In yet another embodiment, the canine is trained only to detect the scent of a virus or disease and is not additionally trained to detect narcotics or explosives. Thus, canines which have undergone basic obedience training but which have not been previously trained to detect narcotics or explosives are preferred to be trained to detect the scent of a virus or a disease. If a canine is trained on both a virus and on narcotics or explosives, then it is not be possible to tell with certainty which scent the canine is tracking.

In another embodiment, the canine is given basic obedience training before live odor training and operational training begin.

Sweeping for Viruses in Public with High Mobility

The trained canine is used in combination with a trained handler to sweep for viruses in an operational setting. The trained canine is brought to a location desired to be swept and moves freely around the location. The canine searches for target odors or scents associated with the virus and is able to follow the target odor or scent back to its source. In one embodiment, the location is an arena, a stadium, an outdoor event, an entry to a building, a parking lot, an office building, a ticket line, a mall, a movie theatre, a school, a college campus, a transportation hub (such as an airport, bus station, train station, or subway), a church, a concert venue, or other area with large numbers of people. Sweeping is performed prior to, during, and/or after an event.

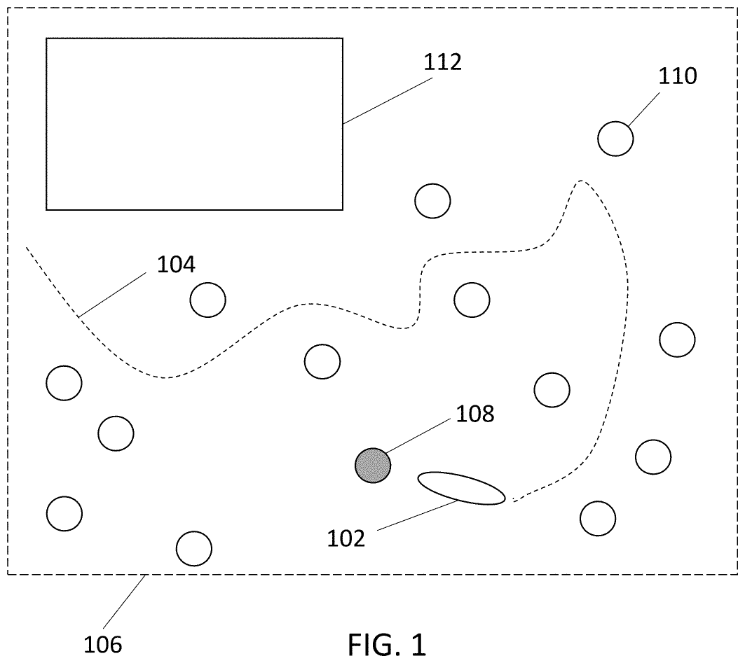

FIG. 1 is an illustration of a trained canine 102 and its path 104 as the canine sweeps a location 106 to detect sources of a virus 108. The trained canine does not slow down people that are not infected with the virus 110 from walking to their destination 112.

During a sweep, canines are visible and normally moving. In one embodiment, trained canines are used as the only layer of security for the location. In another embodiment, trained canines are used in conjunction with law enforcement or security officers. In yet another embodiment, trained canines are used in conjunction with cameras, devices configured to access the Global Positioning System (GPS), and/or other devices with geopositioning or imaging capabilities.

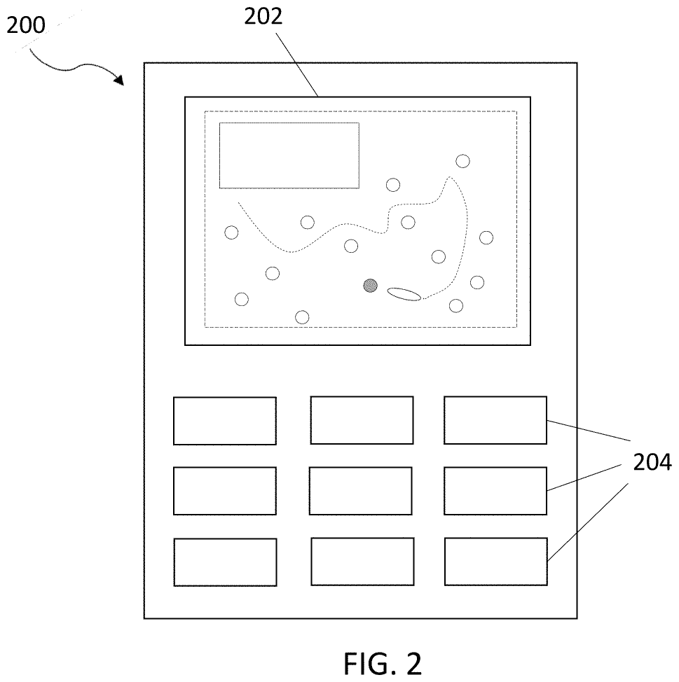

FIG. 2 is an illustration of a device 200 including an application. In one embodiment, the device includes a screen 202. In FIG. 2 the screen shows the trained canine 102 and its path 104 as in FIG. 1. In one embodiment, the device includes buttons 204 operable to manipulate the device 200.

In one embodiment, the device including an application automatically registers detection of a target odor through the application as a report by detecting a response of a canine. The response of the canine that is detected by the device includes trailing a source of the target odor, a strong pull, or other indication by the canine. In a further embodiment, the canine is trained not to bark or growl in order to not appear threatening.

In one embodiment, the device is a wearable device worn by the canine. In a further embodiment, the device communicates with a wearable device worn by the canine, and the wearable device detects the response of the canine and sends the response to the device. Preferably, the wearable device is configured to communicate with the device via BLUETOOTH®, radio frequency (RF), satellite communication, a low-power wide area network (LPWAN), cellular communication, or any other wireless communication known in the art. In one embodiment, the wearable device does not connect to the internet. When the device registers the detection of the target odor, the device generates an alert. The device is in network communication with at least one other device (e.g. at least one remote device), at least one server, at least one edge device, and/or at least one cloud. The alert is sent to the at least one other device, the at least one server, the at least one edge device, and/or the at least one cloud. The report is saved to the at least one other device, the at least one server, the at least one edge device, and/or the at least one cloud. In a further embodiment, the report includes a location of the device when the target odor was detected and/or a time at which the target odor was detected. In one embodiment, the location of the device and/or the time at which the target odor was detected are automatically determined by the application. In another embodiment, the location of the device and/or the time at which the target odor was detected are manually input into the application.

Canines track scents using either air-scent trailing or ground-scent tracking. In air-scent trailing, a canine detects a target scent in the air and follows it to a point of greatest concentration. Humans are always emitting or emanating particles which are carried by wind and air, and as they travel further from their source, their concentration decreases. Canines are able to detect these particles by smell and can determine which areas have a higher concentration and which areas have a lower concentration of the particles. In air-scent trailing, the canine is not following a linear trail but is instead traveling up a concentration gradient of the particles. As the canine travels from low concentrations to high, the canine is moving closer to the source of the particles. In ground-scent tracking, the canine is not detecting particles floating in the air but is instead detecting a trail of particles that have fallen to the ground. In ground-scent tracking, the canine is no longer searching but is instead following a trail. The canine is able to tell which direction the trail leads by following the particles which are fresher. In one embodiment, the trained canine tracks the virus using air-scent tracking, ground-scent tracking, or a combination thereof.

In another embodiment, the canine is trained to detect a plurality of viruses and/or diseases. The canine is trained to generate a separate response for each virus and/or disease of the plurality of viruses and/or diseases. Advantageously, the at least one wearable device is configured to detect the different responses for each virus and/or disease.

In one embodiment, the canine is able to track a scent on a track that is up to an hour old. In another embodiment, the canine is able to track a scent for a distance of up to 800 meters through an urban environment.

When the canine finds the source of the target scent or odor, the canine performs an alert behavior. In one embodiment, the alert behavior is a passive alert. Passive alert is a system where the trained canine displays a non-aggressive response to the target odor. Examples of passive alert behavior include the trained canine lying down, staring, or sitting in front of the source of the target odor. In another embodiment, the canine performs an active alert behavior on target odors. Examples of active alert behaviors include pawing, scratching, barking, or jumping on the source of the target odor. In another embodiment, passive and/or active alert behavior is detected by means of sensors. The sensors include wearable sensors. The sensors further include heartrate detectors, sound detectors, motion detectors, breathing detectors, temperature detectors, canine body language detectors, pressure sensors, air sensors, GPS devices, accelerometers and/or other sensors. For example, and not limitation, in one embodiment, the wearable sensor is configured to determine when the canine has a rapid change in direction and/or movement. Generally, this indicates that the canine has locked on to the scent and is tracking the scent to its source. In yet another embodiment, the canine is trained to apply pressure on the sensor when it identifies a target scent. For example, and not limitation, the sensor is positioned on the front left leg of the canine and the canine is trained to press on the sensor with its right paw when it detects the target scent.

In yet another embodiment, in addition to being trained to perform the sweep, the canine is also trained to perform static detection.

Predictive Analytics to Determine Where to Sweep

There are constant shortages of trained canines, and it is important that this scarce resource is put to use to either screen the largest number of people, or to screen locations where the virus is more likely to be present. Predictive analytics are used to determine which areas and/or which types of areas a trained canine will screen. A predictive analytics program uses as inputs at least one prior detection, the area where the at least one prior detection occurred, and/or the type of area where the at least one prior detection occurred. The area where the at least one prior detection occurred is a geographic area, a zip code, GPS coordinates, or other location identifier. The type of area where the at least one prior detection occurred includes an arena, a stadium, an outdoor park, an entry to a building, a parking lot, an office building, a ticket line, a mall, a movie theatre, a school, a college campus, a transportation hub (such as an airport, bus station, train station, or subway), a church, a concert venue, or other areas with large numbers of people. In one embodiment, the predictive analytics program also uses as an input the time that the at least one prior detection occurred.

The predictive analytics program uses these inputs to determine where to send the trained canines to prioritize areas and types of areas with high numbers of prior detections. For example, if detections are higher in Wake County than in surrounding counties, and if detections are higher at airports than at other types of areas, then the predictive analytics program determines that at least one of the trained canines should be sent to an airport in Wake County.

In another embodiment, the predictive analytics program uses internet or web-based sources such as news articles, statistics, maps, or any other relevant data source as inputs to determine where to sweep. The predictive analytics program is also operable to receive inputs relating to reopening of businesses or reopening of types of businesses to determine locations to sweep. For example, if a large mall is reopening, the predictive analytics program recommends sweeping at the mall or locations near the mall such as airports, stadiums, etc. The predictive analytics according to the present invention also recommend sweeping locations where a large number of people pass through from different origin locations, such as cruise ships, airports, stadiums, etc. This is important to detect viruses and prevent the viruses from spreading, as a person selected from a number of people from different locations is generally more likely to have traveled further and come into contact with more people than a person selected from a number of people from the same location or substantially the same location. By way of example, someone travelling from New York City to Tampa, Fla. is generally more likely to have come into contact with more people recently than someone traveling from Fort Meyers, Florida to Tampa, Fla. The predictive analytics program is also operable to be informed by other data sources, such as license plate info from parking lot cameras, travel statistics for a certain location, venue, etc., and phone or other mobile device location data. Locations such as hospitals, healthcare offices, drug stores, pharmacies, and any other location where sick or unwell people typically visit, as well as locations near these locations, are also operable to be weighted more heavily by a predictive analytics algorithm as locations where increased sweeping is recommended.

In yet another embodiment, the internet or web-based sources includes statistics data including the number of new cases, the number of deaths, emergency department visits, and other similar statistics for a location. The predictive analytics program is configured to determine the probability a person from a particular location is likely to have a specific disease or virus. Advantageously, the predictive analytics program is configured to determine the risk of a person is infected with the specific disease or virus. For example, and not limitation, the predictive analytics program is configured to determine the risk that a person on a flight from Florida to North Carolina has been exposed to the specific disease or virus based on the statistics data. The predictive analytics component is configured to generate an alert and/or at least one recommendation based on the risk. The at least one recommendation includes identifying a location (e.g. an airport terminal) to send a trained canine.

In another embodiment, the device includes a graphical user interface (GUI). The device is configured to display the alert, canine data, and/or the at least one recommendation via the GUI. Advantageously, the GUI is configured to receive user input. For example, a user can search through prior detection data and/or input new detection data.

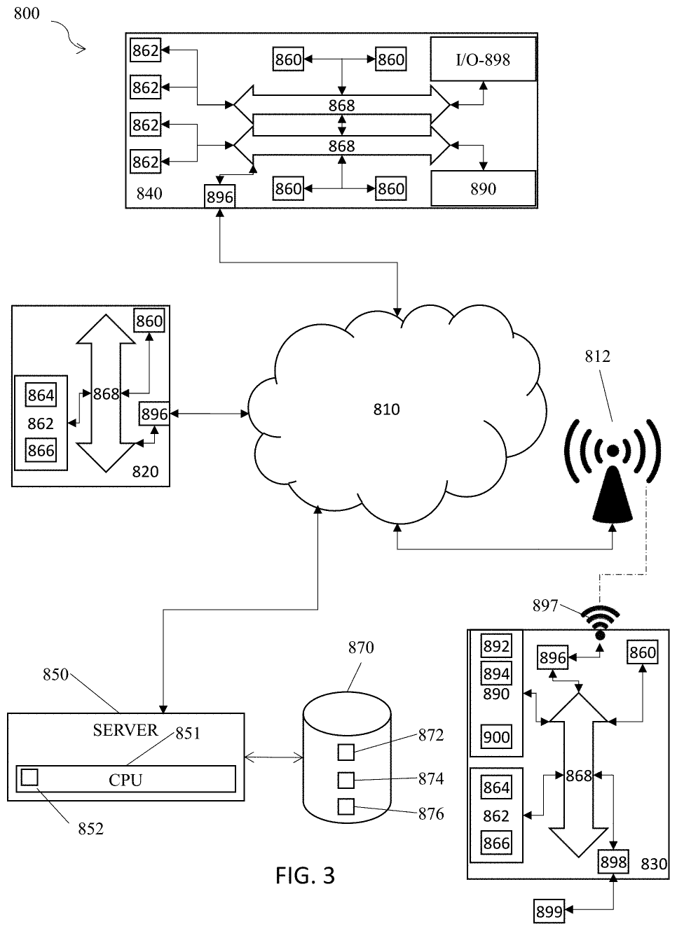

FIG. 3 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 3, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 3, is operable to include other components that are not explicitly shown in FIG. 3, or is operable to utilize an architecture completely different than that shown in FIG. 3. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

The above-mentioned examples are provided to serve the purpose of clarifying the aspects of the invention, and it will be apparent to one skilled in the art that they do not serve to limit the scope of the invention. By nature, this invention is highly adjustable, customizable and adaptable. The above-mentioned examples are just some of the many configurations that the mentioned components can take on. All modifications and improvements have been deleted herein for the sake of conciseness and readability but are properly within the scope of the present invention.

1. A system for detecting a virus or a disease using a trained canine including:
at least one wearable device; and
at least one remote device including a graphical user interface (GUI); and
at least one remote server including a predictive analytics component
wherein the at least one wearable device, the at least one remote server, and the at least one remote device are in network communication;
wherein the at least one wearable device is positioned on the canine;
wherein the at least one wearable device is configured to collect canine data;
wherein the at least one wearable device is further configured to transmit the canine data to the at least one remote device;
wherein the canine data includes positioning data, wherein the positioning data includes location data;
wherein the predictive analytics component is configured to provide at least one recommendation based on input data, wherein the input data includes the canine data and web data, wherein the web data includes information from a web-based source;
wherein the canine is configured to detect the virus or the disease via scent;
wherein the canine is configured to generate a response when the canine detects the virus and/or the disease;
wherein the at least one wearable device is configured to determine when the canine has generated the response;
wherein the at least one wearable device is configured to generate an alert to the at least one remote device based on the response;
wherein the at least one remote device is configured to display the alert and the canine data via the GUI; and
wherein the at least one remote server is configured to store historical data, wherein the historical data includes prior detection data, detection area data, detection area type data, and/or detection time data.

2. The system of claim 1, wherein the canine is trained to detect the virus and/or the disease via volatile organic compounds in air.

3. The system of claim 1, wherein the canine response includes a passive response, wherein the passive response includes lying down, staring, sitting, and/or spinning in circles.

4. The system of claim 1, wherein the canine response includes an active response, wherein the active response includes pawing, scratching, barking, jumping, pulling, and/or a change in pace.

5. The system of claim 1, wherein the at least one wearable device includes at least one sensor, wherein the at least one sensor includes a heart rate sensor, a sound sensor, a motion sensor, an air sensor, a temperature sensor, and/or a Global Positioning System (GPS) sensor.

6. The system of claim 1, wherein the at least one wearable device includes at least one sensor, wherein the at least one sensor is configured to receive pressure from the canine, wherein the applied pressure indicates that the canine has identified the virus and/or disease.

7. The system of claim 1, wherein the virus includes COVID-19 and/or influenza.

8. A system for detecting a virus or a disease using a trained canine including:
at least one wearable device;
at least one remote device including a graphical user interface (GUI); and
at least one remote server including a predictive analytics component;
wherein the at least one wearable device, the at least one remote device, and the at least one remote server are in network communication;
wherein the at least one wearable device is positioned on the canine;
wherein the at least one wearable device is configured to collect canine data;
wherein the at least one wearable device is further configured to transmit canine data to the at least one remote device and the at least one remote server;
wherein the canine data includes positioning data, wherein the positioning data includes location data;
wherein the canine is configured to detect the virus or the disease via scent;
wherein the canine is configured to generate a response when the canine detects the virus and/or the disease;
wherein the at least one wearable device is configured to determine when the canine has generated the response;
wherein the at least one wearable device is configured to generate an alert to the at least one remote device;
wherein the at least one remote device is configured to display the alert and the canine data via the GUI; and
wherein the at least one remote server is further configured to store historical data, wherein the historical data includes prior detection data, detection area data, detection area type data, and/or detection time data.

9. (canceled)

10. The system of claim 8, wherein the detection area data includes the area where at least one prior detection occurred, wherein the detection area data includes a geographic area, a zip code, and/or global positioning coordinates.

11. The system of claim 8, wherein the detection area type data includes the type of area where at least one prior detection occurred, wherein the detection area type data includes an arena, a stadium, an outdoor park, an entry to a building, a parking lot, an office building, a ticket line, a mall, a movie theater, a school, a college campus, a transportation hub, a church, and/or a concert venue.

12. The system of claim 8, wherein the predictive analytics component is configured to provide at least one recommendation based on input data, wherein the input data includes the canine data and web data, wherein the web data includes information from a web-based source.

13. The system of claim 12, wherein the web data includes flight data and disease data, wherein the flight data includes a departure location of a flight and an arrival location of the flight, wherein the disease data includes statistics relating to the infection rate for the departure location of the flight, wherein the predictive analytics component is configured to determine the risk of a person having the disease or the virus based on the disease data, wherein the predictive analytics component is configured to provide at least one recommendation based on the risk of the person having the disease or the virus, wherein the at least one recommendation includes at least one location to send the canine.

14. The system of claim 8, wherein the predictive analytics component is configured to provide a first recommendation, wherein the first recommendation includes a location, a business, an event, and/or a venue to send a canine, wherein the predictive analytics component is configured to provide a second recommendation, wherein the predictive analytics component is further configured to identify a priority level for the first recommendation and the second recommendation, wherein the first recommendation is configured to receive a first priority level, wherein the second recommendation is configured to receive a second priority level, wherein the first priority level is greater than the second priority level.

15. The system of claim 8, wherein at least one wearable device includes at least one sensor, wherein the at least one sensor includes a heart rate sensor, a sound sensor, a motion sensor, an air sensor, a temperature sensor, and/or a Global Positioning System (GPS) sensor.

16. The system of claim 8, wherein the canine is trained to detect the virus and/or the disease via volatile organic compounds in air.

17. The system of claim 8, wherein the virus includes COVID-19 and/or influenza.

18. A method of detecting a virus or a disease in a public space comprising:
providing a canine including at least one wearable device in the public space;
monitoring the movement of the canine through and/or around the public space;
the canine detecting at least one volatile organic compound specific to the virus or the disease;
the canine generating at least one response when the canine detects the at least one voltaic organic compound;
the at least one wearable device detecting the at least one response;
the at least one wearable device capturing canine data, wherein the canine data includes positioning data of the canine;
the at least one wearable device transmitting an alert and the canine data to at least one remote device; and
displaying the alert and the canine data via a graphical user interface (GUI) of the at least one remote device.

19. The method of claim 18, further comprising storing the positioning data of the canine on a remote server, wherein the positioning data of the canine includes the area where at least one detection occurred, and wherein the positioning data includes a geographic area, a zip code, and/or global positioning coordinates.

20. The method of claim 19, further comprising providing at least one recommendation via the remote server based on historical data, wherein the remote server includes a predictive analytics component, wherein the historical data includes prior detection data, detection area data, detection area type data, and/or detection time data, and wherein the at least one recommendation includes at least one location to send the canine.

21. The method of claim 20, wherein the at least one recommendation provided by the predictive analytics component is additionally based on input data, wherein the input data includes canine data and web data, wherein the web data includes information from a web-based source, and wherein the web data includes flight data and disease data.
